(19) United States
(12) Patent Application Publication
(10) Pub. No.: US 2006/0162100 A1
(43) Pub. Date: Jul. 27, 2006

(54) Dye mixtures of fibre-reactive azo dyes and use thereof for dyeing material containing hydroxy-and/or carboxamido groups

(75) Inventors: Warren James Ebenezer, Cheshire (GB); Werner Russ, Florsheim-Wicker (DE)

Correspondence Address: CONNOLLY BOVE LODGE & HUTZ, LLP, P O BOX 2207, WILMINGTON, DE, 19899, US

(73) Assignee: DyStar Textilfarben GmbH & Co. Deutschland KG, Frankfurt am Main (DE)

(21) Appl. No.: 10/533,965

(22) PCT Filed: Nov. 4, 2003
(86) PCT No.: PCT/EP03/12271

§ 371 Date: May 5, 2005

(30) Foreign Application Priority Data
Nov. 8, 2002 (GB) 0226151.9

(51) Int. Cl. C09B 67/00

(52) U.S. Cl. 8/638

(57) ABSTRACT

Mixtures of fibre reactive dyes comprising one or more dyestuffs of the formula (I) 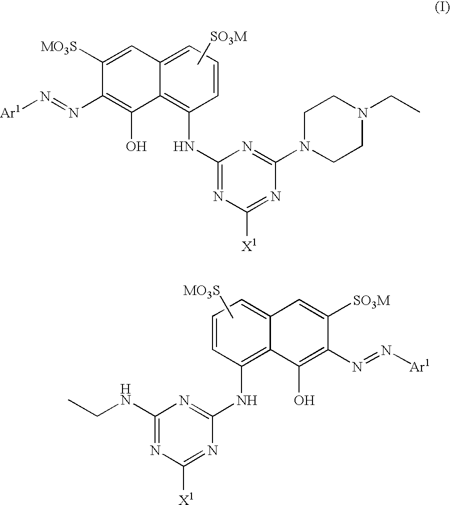
and one or more dyestuffs of the general formula (II)

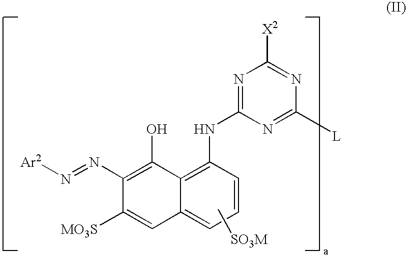

wherein Ar¹, Ar², X¹, X², L and M are as defined in claim 1.

The present invention relates to the field of fibre-reactive dyes.

Dyestuffs containing chromophores linked via a piperazine type linking unit are known from literature and are described for example in EP-A-01 26265, EP-A-0693538, WO99/05224 and WO00/08104.

The inventors of the present invention have surprisingly found that mixtures of dyestuffs of the general formula (I) and dyestuffs of the general formula (II) give excellent application properties on cellulose containing material, especially high levels of solubility in water or salt solution, high fixation degrees, ease of washing out the unfixed dyestuff, good fastness to light and water as well as robustness to process variables.

The present invention claims mixtures of fibre reactive dyes comprising one or more dyestuffs of the formula (I) 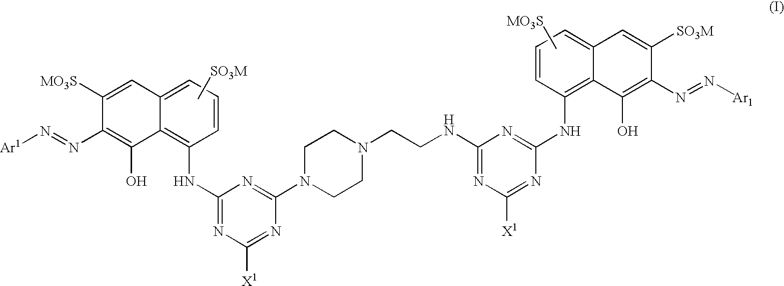
and one or more dyestuffs of the general formula (II) 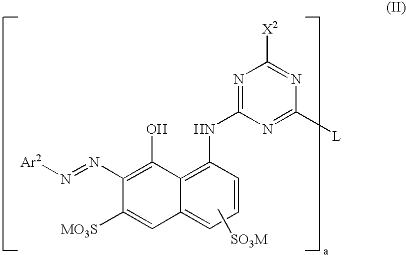
where
X¹, x² independently are a labile atom or group;
Ar¹ is an aromatic residue substituted by at least one —SO₃M group,
M is hydrogen or alkali metal, especially sodium,
Ar² is an aromatic radical substituted with at least one —SO₃M group,
a is 1 or 2
   wherein,
   if a is 2
   L is a divalent radical typically of the form (y) 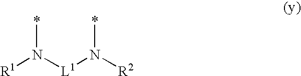
      where
      R¹ and R² are independently hydrogen, C₁-C₄ alkyl optionally substituted by —OR, —SR, —SO₃M, or —X,
      or a phenyl group optionally substituted by a sulfonic acid group, —OR, —C₁-C₄ alkyl, or —NR′COR
      L¹ is alkylene or arylene optionally substituted by a sulfonic acid group, —OR, —C₁-C₄ alkyl or —NR′COR, —COOR
      wherein R and R′ are independently hydrogen or C₁-C₄ alkyl and
      X is halogen
      or R¹ and R² are independently optionally substituted alkyl, or
   L is aminoethylpiperazine, under the proviso that if L is aminopiperazine, Ar¹ and Ar² are different or
   if a is 1
   L is a monovalent radical —NR³R⁴, —SR³ or —OR³
      where
      R³ and R⁴ have one of the meanings of R¹ and R² or for —NR³R⁴, R³ and R⁴ can form a cyclic structure of the form (o) 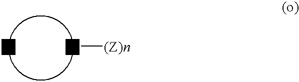
      where
      U is a C₄-C₆ alkyl residue optionally substituted by a substituent of formula Z and optionally interrupted by heteroatoms or heteroatom-containing groups such as —O—, —NR¹,
      n is 1, 2 or 3 and
      Z is hydrogen, optionally substituted C₁-C₄ alkyl, —OR⁵, —CO₂R⁵, —COR⁵ and
      R⁵ is hydrogen, optionally substituted C₁-C₄ alkyl, optionally substituted vinyl, optionally substituted phenyl.

(C₁-C₄)-alkyl groups may be straight-chain or branched and are preferably for example methyl, ethyl, n-propyl, i-propyl or n-butyl. Substituted alkyl groups are preferably substituted by hydroxyl, (C₁-C₄)-alkoxy, halogen or carboxyl groups. Substituted vinyl groups are for example —C(CH₃)═CH₂ or —CH═CHCOOH, substituted phenyl groups are for example phenyl substituted by —COOH, or —SO₃M.

Preferred embodiments of the invention are mixtures of one or more dyestuffs of the general formula (I) and one or more dyestuffs of the general formula (II)

where

X¹ and X² are independently chlorine, fluorine or 3 or 4-carboxypyridinium especially preferred is chlorine,
Ar¹ and Ar² are independently a naphthyl residue substituted by at least one sulfo group (q-1) 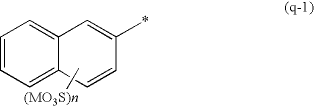
   where n is 1 to 3, especially preferred (q-11) or (q-12) 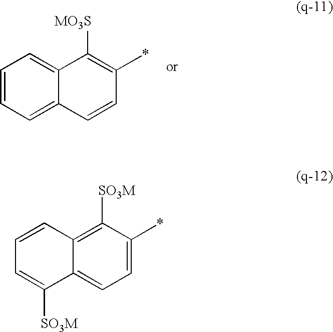
   or are a phenyl residue substituted by at least one sulfo group (q-2) 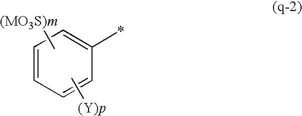
   wherein
   m is 1 or 2
   p is 1 or 2
   Y is independently hydrogen, halogen, R⁵, OR⁵, SR⁵, NHCOR⁵, where R⁵ is as defined above, especially preferred Y is methyl.

When a is 2 L¹ is preferred to be an optionally substituted phenylene or an alkylene residue optionally substituted or optionally interrupted by heteroatoms or heteroatom containing groups, wherein L¹-N-R¹ or L¹-N-R² may contain a cyclic structural feature such as 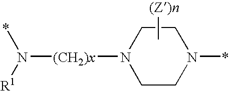
where n and R¹ are as defined above and x is 2 to 5 and Z′ has one of the meanings of Z.

When a is 1 L is preferably morpholine or N-Methylsulfanilic acid.

The dyestuffs of the formula (I) are contained in the mixture in quantity of 1% by weight to 99% by weight preferably in a mixing ration of 10% by weight to 90% by weight and the dyestuffs of the formula (II) are contained in the mixture in a mixing ratio of 99% by weight to 1% by weight, preferably in a mixing ratio of 90% by weight to 10% by weight.

Dyestuff mixtures according to the invention can be obtained upon reacting chromophores of formula (III) 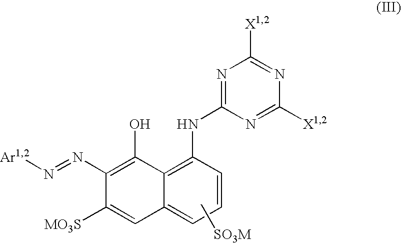
with an appropriate mixture of 2-aminoethylpiperazine and a diamine H-L-H, or amine H-L, wherein L is as defined above, followed by precipitation using methylated spirits and conventional filtration.

The dyestuffs of the present invention can be present as a preparation in solid or liquid (dissolved) form. In solid form they generally contain the electrolyte salts customary in the case of water-soluble and in particular fibre-reactive dyes, such as sodium chloride, potassium chloride and sodium sulfate, and also the auxiliaries customary in commercial dyes, such as buffer substances capable of establishing a pH in aqueous solution between 3 and 8, such as sodium acetate, sodium borate, sodium bicarbonate, sodium citrate, sodium dihydrogenphosphate and disodium hydrogenphosphate, small amounts of siccatives or, if they are present in liquid, aqueous solution (including the presence of thickeners of the type customary in print pastes), substances which ensure the permanence of these preparations, for example mold preventatives.

In general, the dyestuff mixtures of the present invention are present as dye powders containing 10 to 80% by weight, based on the dye powder or preparation, of a strength-standardizing colorless diluent electrolyte salt, such as those mentioned above. These dye powders may additionally include the aforementioned buffer substances in a total amount of up to 10%, based on the dye powder. If the dye mixtures of the present invention are present in aqueous solution, the total dye content of these aqueous solutions is up to about 50% by weight, for example between 5 and 50% by weight, and the electrolyte salt content of these aqueous solutions will preferably be below 10% by weight, based on the aqueous solutions. The aqueous solutions (liquid preparations) may include the aforementioned buffer substances in an amount which is generally up to 10% by weight, for example 0.1 to 10% by weight, preference being given to up to 4% by weight, especially 2 to 4% by weight.

The dyestuff mixtures of the instant invention are reactive dyestuffs suitable for dyeing and printing hydroxy- and/or carboxamido-containing fibre materials by the application and fixing methods numerously described in the art for fibre-reactive dyes. They provide exceptionally strong and economic shades. Such dyes especially when used for exhaust dyeing of cellulosic materials can exhibit excellent properties including build-up, light-fastness, high levels of solubility in water or salt solution, high fixation degrees, ease of washing out the unfixed dyestuff, as well as robustness to process variables.

They are also wholly compatible with similar dyes designed for high temperature (80-100° C.) application to cellulosic textiles, and thus lead to highly reproducible application processes, with short application times. The present invention therefore also provides for use of the inventive dyestuffs for dyeing and printing hydroxy- and/or carboxamido-containing fibre materials and processes for dyeing and printing such materials using a dyestuff according to the invention. Usually the dyestuff is applied to the substrate in dissolved form and fixed on the fibre by the action of an alkali or by heating or both.

Hydroxy-containing materials are natural or synthetic hydroxy-containing materials, for example cellulose fiber materials, including in the form of paper, or their regenerated products and polyvinyl alcohols. Cellulose fiber materials are preferably cotton but also other natural vegetable fibers, such as linen, hemp, jute and ramie fibres. Regenerated cellulose fibers are for example staple viscose and filament viscose.

Carboxamido-containing materials are for example synthetic and natural polyamides and polyurethanes, in particular in the form of fibers, for example wool and other animal hairs, silk, leather, nylon-6,6, nylon-6, nylon-11, and nylon-4.

Application of the inventive dyestuffs is by generally known processes for dyeing and printing fiber materials by the known application techniques for fibre-reactive dyes. The dyestuffs according to the invention are highly compatible with similar dyes designed for high temperature (80-100° C.) applications and are advantageously useful in exhaust dyeing processes.

Similarly, the conventional printing processes for cellulose fibers, which can either be carried out in single-phase, for example by printing with a print paste containing sodium bicarbonate or some other acid-binding agent and the colorant, and subsequent steaming at appropriate temperatures, or in two phases, for example by printing with a neutral or weakly acid print paste containing the colorant and subsequent fixation either by passing the printed material through a hot electrolyte-containing alkaline bath or by overpadding with an alkaline electrolyte-containing padding liquor and subsequent batching of this treated material or subsequent steaming or subsequent treatment with dry heat, produce strong prints with well defined contours and a clear white ground. Changing fixing conditions has only little effect on the outcome of the prints. Not only in dyeing but also in printing the degrees of fixation obtained with dye mixtures of the invention are very high. The hot air used in dry heat fixing by the customary thermofix processes has a temperature of from 120 to 200° C. In addition to the customary steam at from 101 to 103° C., it is also possible to use superheated steam and high pressure steam at up to 160° C.

The inventive dyestuffs can in addition be used to produce inks useful for printing the substrates described above, for example textiles, especially cellulosic textiles, and paper. Such inks can be used in all technologies, for example conventional printing, ink-jet printing or bubble-jet printing (for information on such printing technologies see for example Text. Chem. Color, Volume 19(8), pages 23 ff and Volume 21, pages 27 ff).

Acid-binding agents responsible for fixing the dyes to cellulose fibers are for example water-soluble basic salts of alkali metals and of alkaline earth metals of inorganic or organic acids, and compounds, which release alkali when hot. Of particular suitability are the alkali metal hydroxides and alkali metal salts of weak to medium inorganic or organic acids, the preferred alkali metal compounds being the sodium and potassium compounds. These acid-binding agents are for example sodium hydroxide, potassium hydroxide, sodium carbonate, sodium bicarbonate, potassium carbonate, sodium formate, sodium dihydrogenphosphate and disodium hydrogenphosphate.

Treating the dyestuffs according to the invention with the acid-binding agents, with or without heating, bonds the dyes chemically to the cellulose fibers. Especially the dyeings on cellulose, after they have been given the usual aftertreatment of rinsing to remove unfixed dye portions, show excellent properties.

The dyeings of polyurethane and polyamide fibers are customarily carried out from an acid medium. The dyebath may contain for example acetic acid and/or ammonium sulfate and/or acetic acid and ammonium acetate or sodium acetate to bring it to the desired pH. To obtain a dyeing of acceptable levelness it is advisable to add customary leveling auxiliaries, for example based on a reaction product of cyanuric chloride with three times the molar amount of an aminobenzenesulfonic acid or aminonaphthalenesulfonic acid or based on a reaction product of for example stearylamine with ethylene oxide. In general the material to be dyed is introduced into the bath at a temperature of about 40° C. and agitated therein for some time, the dyebath is then adjusted to the desired weakly acid, preferably weakly acetic acid, pH, and the actual dyeing is carried out at temperature between 60 and 98° C. However, the dyeings can also be carried out at the boil or at temperatures up to 120° C. (under superatmospheric pressure).

The examples hereinbelow serve to illustrate the invention. Parts and percentages are by weight, unless otherwise stated. Parts by weight relate to parts by volume as the kilogram relates to the liter. The compounds described in the examples in terms of a formula are indicated in the form of the free sulphonic acids, but as in general they are prepared and isolated in the form of their alkali metal salts, such as lithium, sodium or potassium salts, and used for dyeing in the form of these salts. The starting compounds and components mentioned in the form of the free acid in the examples hereinbelow may be used in the synthesis as such or similarly in the form of their salts, preferably alkali metal salts.

### EXAMPLE 1

A 1:1 molar mixture of 2-aminoethylpiperazine (4) and ethylenediamine (5) (0.006 mol) was added to a stirred suspension of the dichlorotriazinyl red dye(3) (0.012 mol) in water (350 mols) at pH 6. The pH was adjusted and maintained at pH 10 by the addition of 2N NaOH solution. After three 10 hours, chromatography indicated that the reaction was complete and the pH was adjusted to 6 with 2N HCl before precipitating the product by addition of methylated spirits. The resulting solid was filtered off and dried to give a dark red powder (11.3 g). Analytical data were consistent with a 1:1 mixture of the two dyes (6) and (7).

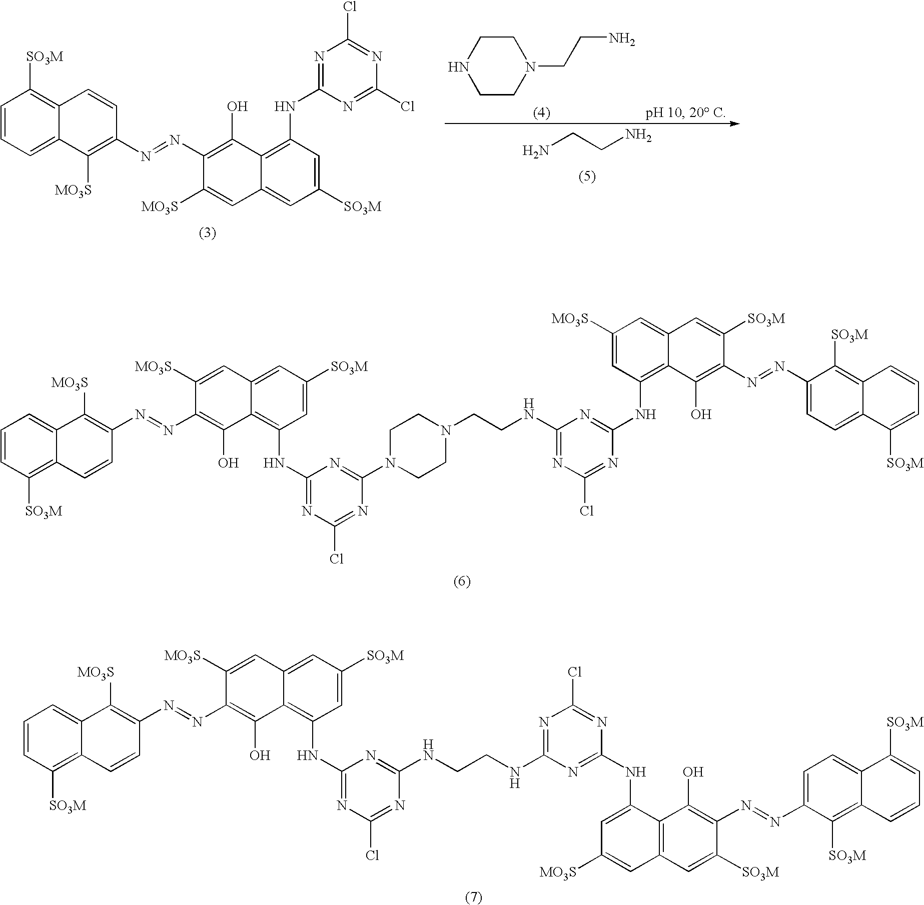

The examples herein below describe further dye mixtures according to the invention. They may be prepared according to the invention either by mechanically mixing the individual dyes or else chemically, for example similarly to the above illustrative embodiment, using as starting compounds of general formula (III), in which X is for example chlorine and Ar¹ and Ar² are for example:

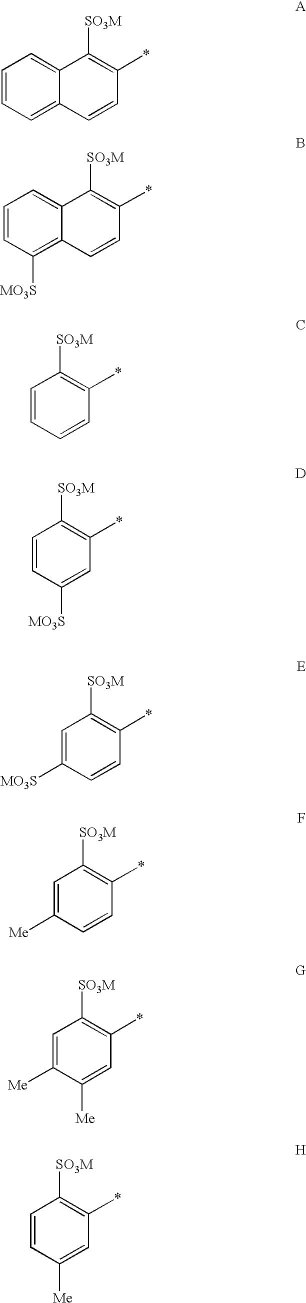

2-aminopiperazine and a diamine H-L-H or amine H-L, wherein L is for example a residue of formula a to af

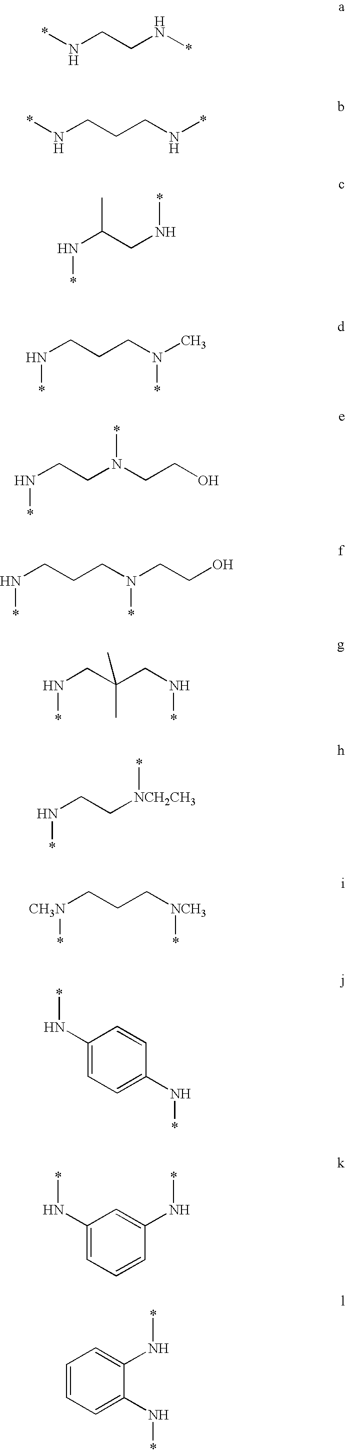

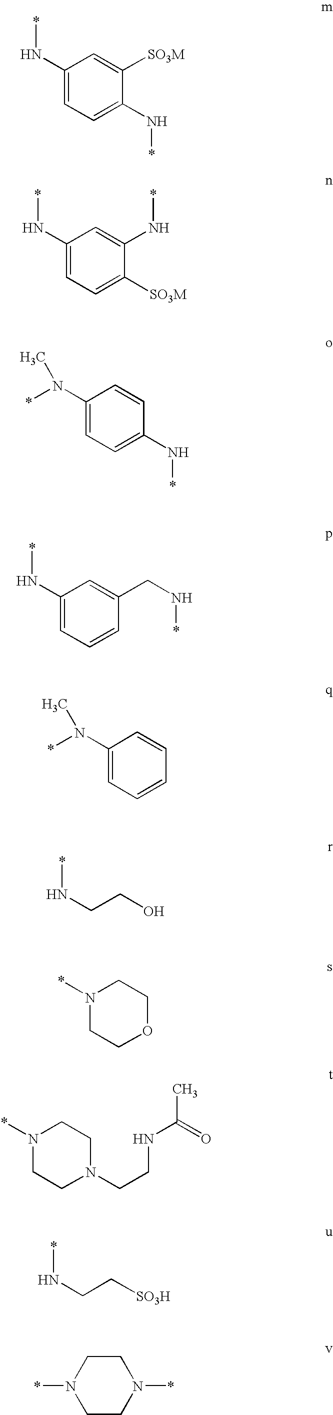

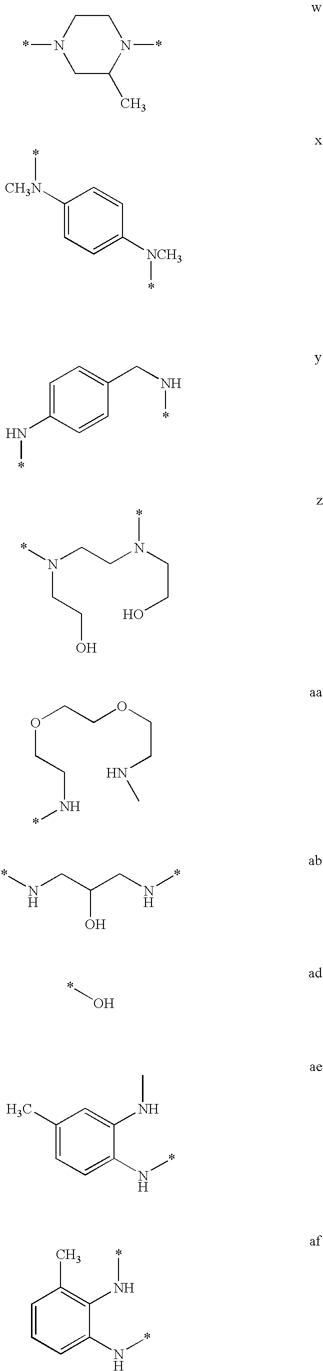

Following exactly analogous procedures the following dyes (examples 2-56) were synthesized giving 1:1 mixtures of the respective dyestuff (8) and (9)

| | |
|---|---|
| | (8) |
| 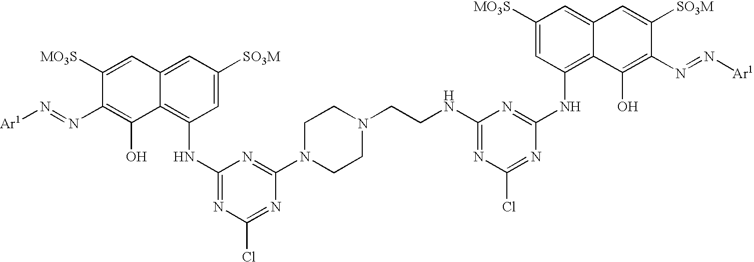 | |
| | (9) |
| 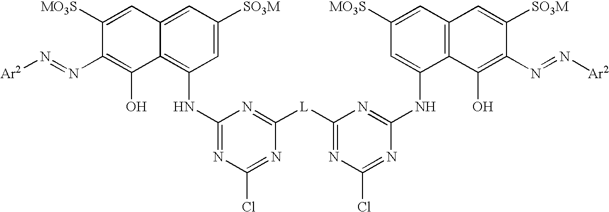 | |

| Example No. | Ar¹ | Ar² | L |
|---|---|---|---|
| 2 | A | A | a |
| 3 | A | A | b |
| 4 | A | A | c |
| 5 | A | A | d |
| 6 | A | A | e |
| 7 | A | A | f |
| 8 | A | A | g |
| 9 | A | A | h |
| 10 | A | A | k |
| 11 | A | A | l |
| 12 | A | A | p |
| 13 | B | B | a |
| 14 | B | B | d |
| 15 | B | B | g |
| 16 | B | B | k |
| 17 | B | B | l |
| 18 | B | B | m |
| 19 | B | B | o |
| 20 | B | B | p |
| 21 | A | G | j |
| 22 | A | G | k |
| 23 | A | G | l |
| 24 | B | F | k |
| 25 | B | F | l |
| 26 | B | F | o |
| 27 | B | F | p |
| 28 | C | C | a |
| 29 | C | C | k |
| 30 | C | C | l |
| 31 | F | F | a |
| 32 | F | F | k |
| 33 | F | F | l |
| 34 | D | D | k |
| 35 | D | D | o |
| 36 | E | E | l |
| 37 | H | H | m |
| 38 | H | H | n |
| 39 | G | G | l |
| 40 | G | G | n |
| 41 | B | B | v |
| 42 | F | F | v |
| 43 | B | B | w |
| 44 | F | F | w |
| 45 | B | B | x |
| 46 | F | F | x |
| 47 | B | B | f |
| 48 | F | F | y |
| 49 | F | F | z |
| 50 | B | B | aa |
| 51 | B | B | j |
| 52 | F | F | j |
| 53 | F | F | o |
| 54 | A | A | ab |
| 55 | B | B | ae |
| 56 | B | B | af |

Examples 57-71 consist of mixtures of dyes of the form (8) and (10).

| | |
|---|---|
| | (10) |
| 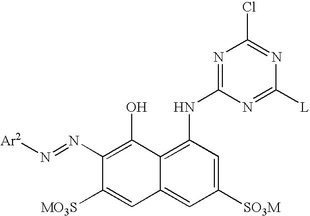 | |

| Example No. | Ar¹ | Ar² | L |
|---|---|---|---|
| 57 | A | A | q |
| 58 | A | A | r |
| 59 | A | A | u |
| 60 | A | A | t |
| 61 | B | B | q |
| 62 | B | B | s |
| 63 | B | B | t |
| 64 | B | B | u |
| 65 | F | F | q |
| 66 | F | F | s |
| 67 | F | F | t |
| 68 | C | C | s |
| 69 | C | C | t |
| 70 | G | G | u |
| 71 | B | B | ad |

All these dyestuff mixtures give excellent application properties on cellulose containing material, especially high levels of solubility in water or salt solution, high fixation degrees, ease of washing out the unfixed dyestuff, good fastness to light and water as well as robustness to process variables.

1. Mixture of fibre reactive dyes comprising one or more dyestuffs of the formula (I) 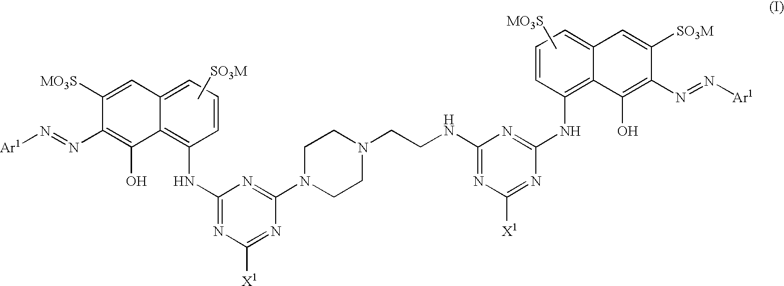
and one or more dyestuffs of the general formula (II) 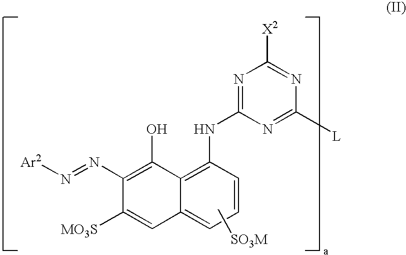
where
X¹, X² are independently a labile atom or group;
Ar¹ is an aromatic residue substituted by at least one —SO₃M group;
M is hydrogen or alkali metal;
Ar² is an aromatic radical substituted with at least one —SO₃M group;
a is 1 or 2
wherein,
if a is 2
L is a divalent radical typically of the form (y) 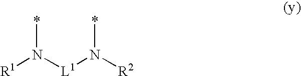
where
R¹ and R² are independently hydrogen, C₁-C₄ alkyl optionally substituted by —OR, —SR, —SO₃M or X, or
a phenyl group optionally substituted by a sulfonic acid group, —OR, —C₁-C₄-alkyl, or NR′ COR and
L¹ is arylene or alkylene optionally substituted by a sulfonic acid group, —OR, —C₁-C₄-alkyl —COOR,
wherein R and R′ are independently hydrogen or C₁-C₄ alkyl and X is halogen or
L is aminoethylpiperazine, under the proviso that if L is aminopiperazine, Ar¹ and Ar² are different or
if a is 1
L is a monovalent radical —NR³R⁴, —SR³ or —OR³
where
R³ and R⁴ have one of the meanings of R¹ and R² or for
—NR³R⁴, R³ and R⁴ can form a cyclic structure of the form (o) 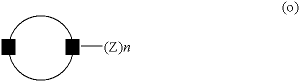
where
U is an C₄- C₆ alkyl residue optionally substituted by a substituent of formula Z and optionally interrupted by heteroatoms or heteroatom-containing groups,
n is 1, 2 or 3 and
Z is hydrogen, optionally substituted C₁-C₄ alkyl, —OR⁵, —CO₂R⁵, —COR⁵ and
R⁵ is hydrogen, optionally substituted C₁-C₄ alkyl, optionally substituted vinyl, optionally substituted phenyl.

2. Dyestuff mixture according to claim 1
wherein
X¹ and X² is independently chlorine, fluorine or 3 or 4-carboxypyridinium;
Ar¹ and Ar² is independently a naphthyl residue substituted by at least one sulfo group (q-1) 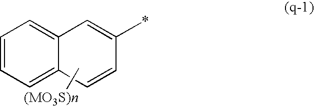
where n is 1 to 3
or is a phenyl residue substituted by at least one sulfo group (q-2) 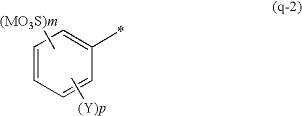
wherein
m is 1 or2
p is 1 or 2 and
Y is independently hydrogen, halogen, R⁵, OR⁵, SR⁵, NHCOR⁵,
where R⁵is as given in claim 1.

3. Dyestuff mixture according to claim 1
wherein
X¹ and X² is chlorine;
Ar¹ and Ar² are independently a naphthyl residue of the formula (q-11) or (q-12) 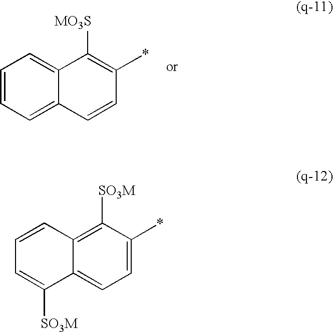
or are a phenyl residue substituted by at least one sulfo group (q-2) 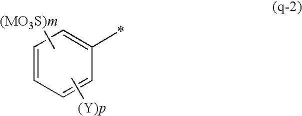
wherein
m is 1 or2
p is 1 or 2 and
Y is methyl.

4. Dyestuff mixture according to claim 1 wherein a is 1 and L is morpholine.

5. A dye mixture according to claim 1 wherein a dye of formula (I) is present in the mixture in an amount of from 1% by weight to 99% by weight and a dye of the formula (II) is present in the mixture in an amount of from 99% by weight to 1% by weight.

6. A dye mixture according to claim 1 wherein a dye of formula (I) is present in the mixture in an amount of from 10% by weight to 90% by weight and a dye of the formula (II) is present in the mixture in an amount of from 90% by weight to 10% by weight.

7. A process for preparing a dye mixture as claimed in claim 1, which comprises reacting chromophores of formula (III) 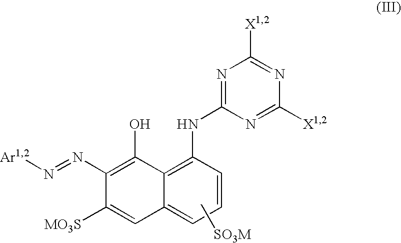
wherein Ar¹, Ar², X¹, X² and M are as defined in claim 1 with a mixture of 2-aminoethylpiperazine and a diamine H-L-H, or amine H-L, wherein L is as defined above, followed by precipitation using methylated spirits and conventional filtration.

8. A process for dyeing hydroxy- and/or carboxamido-containing fiber material which comprises applying dyestuffs or dyestuff mixtures to the material and the dyes of claim 1 are fixed to the material by means of (1) heat, (2) with the aid of an alkali or (3) by means of heat and with the aid of an alkali.

9. A dye mixture according to claim 1, wherein
M is sodium;
U is an C₄-C₆ alkyl residue optionally substituted by a substituent of formula Z and optionally interrupted by heteroatoms or heteroatom-containing group containing —O—or —NR¹.

10. A dye mixture according to claim 4 wherein the dye of formula (I) is present in the mixture in an amount of from 10% by weight to 90% by weight and the dye of the formula (II) is present in the mixture in an amount of from 90% by weight to 10% by weight.
